(19) United States
(12) Patent Application Publication
(10) Pub. No.: US 2026/0254029 A1
(43) Pub. Date: Aug. 27, 2026

(54) HOLDER FOR TRACTION BATTERY PACK

(71) Applicant: Ford Global Technologies, LLC, Dearborn, MI (US)

(72) Inventor: John Marshall Penney, Livonia, MI (US)

(21) Appl. No.: 19/059,888

(22) Filed: Feb. 21, 2025

(51) Int. Cl. H01M 50/249; H01M 10/658; H01M 50/211; H01M 50/342; H01M 50/516; H01M 50/557; H01M 50/588

(52) U.S. Cl. CPC H01M 50/249; H01M 10/658; H01M 50/211; H01M 50/3425; H01M 50/516; H01M 50/557; H01M 50/588; H01M 2220/20

(57) ABSTRACT

A battery pack assembly includes a cell stack including battery cells disposed along a cell stack axis and a side frame alongside the cell stack. The battery cells have terminals that extend through one of a plurality of apertures in the side frame. A pectinated holder slidably engages with the side frame.

### TECHNICAL FIELD

This disclosure relates generally to a holder used within a battery pack and, more particularly, to a holder that can slide to engage frame of the battery pack to hold, for example, a thermal barrier or terminal.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack assembly, including: a cell stack including a plurality of battery cells disposed along a cell stack axis; a side frame alongside the cell stack, the plurality of battery cells having a plurality of terminals that each extend through one of a plurality of apertures in the side frame; and a pectinated holder that slidably engages the side frame.

In some aspects, the techniques described herein relate to a battery pack assembly, wherein the pectinated holder and the side frame are an electrically insulative material.

In some aspects, the techniques described herein relate to a battery pack assembly, wherein the pectinated holder includes a plurality of slots that receive at least one terminal within the plurality of terminals.

In some aspects, the techniques described herein relate to a battery pack assembly, wherein the pectinated holder is slidably received within at least one opening in the side frame when the pectinated holder engages the side frame.

In some aspects, the techniques described herein relate to a battery pack assembly, wherein the plurality of apertures in the side frame each extends from a first side of the side frame, through the side frame, to an second side of the side frame, the second side opposite the first side, wherein the at least one opening opens to a third side of the side frame that is transverse to both the first side and the second side.

In some aspects, the techniques described herein relate to a battery pack assembly, wherein the third side is an upper side of the side frame.

In some aspects, the techniques described herein relate to a battery pack assembly, wherein the pectinated holder includes a plurality of fingers, the plurality of terminals extending between the plurality of fingers when the pectinated holder engages the side frame.

In some aspects, the techniques described herein relate to a battery pack assembly, wherein the pectinated holder slidably engages with the side frame to position the plurality of terminals between the plurality of fingers.

In some aspects, the techniques described herein relate to a battery pack assembly, further including a battery pack enclosure providing an interior, the cell stack and the side frame housed within the interior.

In some aspects, the techniques described herein relate to a battery pack assembly, wherein the cell stack includes a plurality of thermal barriers, wherein the pectinated holder includes a plurality of slots that each receive a portion of at least one thermal barrier within the plurality of thermal barriers.

In some aspects, the techniques described herein relate to a battery pack assembly, wherein the pectinated holder is configured to limit axial movement of the plurality of thermal barriers.

In some aspects, the techniques described herein relate to a battery pack assembly, wherein the pectinated holder is a first pectinated holder that includes a plurality of first slots that each receive at least one terminal within the plurality of terminals, and further including a second pectinated holder that slidably engages the side frame.

In some aspects, the techniques described herein relate to a battery pack assembly, wherein second pectinated holder includes a plurality of slots that each receive a portion of at least one thermal barrier of the cell stack.

In some aspects, the techniques described herein relate to a battery pack assembly, wherein the pectinated holder includes at least one vent opening.

In some aspects, the techniques described herein relate to a battery pack assembly, further including a membrane that covers the at least one vent opening.

In some aspects, the techniques described herein relate to a battery pack assembly, including: a cell stack having a plurality of battery cells and a plurality of thermal barriers disposed along a cell stack axis; a side frame alongside the cell stack; and a thermal barrier holder that slidably engages with the side frame and is configured to receive a portion of at least one of the thermal barriers within the plurality of thermal barriers.

In some aspects, the techniques described herein relate to a battery pack assembly, wherein the thermal barrier holder is comb-shaped.

In some aspects, the techniques described herein relate to a battery pack assembly, further including a terminal holder that slidably engages with the side frame separately from the thermal barrier holder.

In some aspects, the techniques described herein relate to a battery pack assembly, wherein the plurality of battery cells include a plurality of tab terminals, at least some of the tab terminals within the plurality of tab terminals received within a slot of the terminal holder.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates an expanded view of the battery pack from FIG. 1.

FIG. 3 illustrates a perspective view of a battery cell from the battery pack of FIG. 2.

FIG. 4 illustrates a perspective view of a cell stack from the battery pack of FIG. 2.

FIG. 5 illustrates a perspective view of a side frame from the battery pack of FIG. 2 along with a thermal barrier holder and a terminal holder that can slidable engage the side frame.

FIG. 6 illustrates a perspective view of a portion of the side frame of FIG. 5 showing a thermal barrier of the cell stack moving toward an installed position where the thermal barrier is partially received within a groove of the side frame.

FIG. 7 illustrates the thermal barrier of FIG. 6 partially received within the groove of the side frame.

FIG. 8 illustrates the thermal barrier held within the groove with the thermal barrier holder.

FIG. 9 illustrates a pair of terminals of battery cells received within a groove of a terminal holder and extending through an opening in the side frame.

FIG. 10 illustrates the pair of terminals of FIG. 9 joined together in a variation of what is shown in FIG. 4.

### DETAILED DESCRIPTION

This disclosure details exemplary holders for a battery pack. The holders can engage with a frame that is alongside a cell stack. The holders can be used to hold various components, such as thermal barriers or terminals.

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

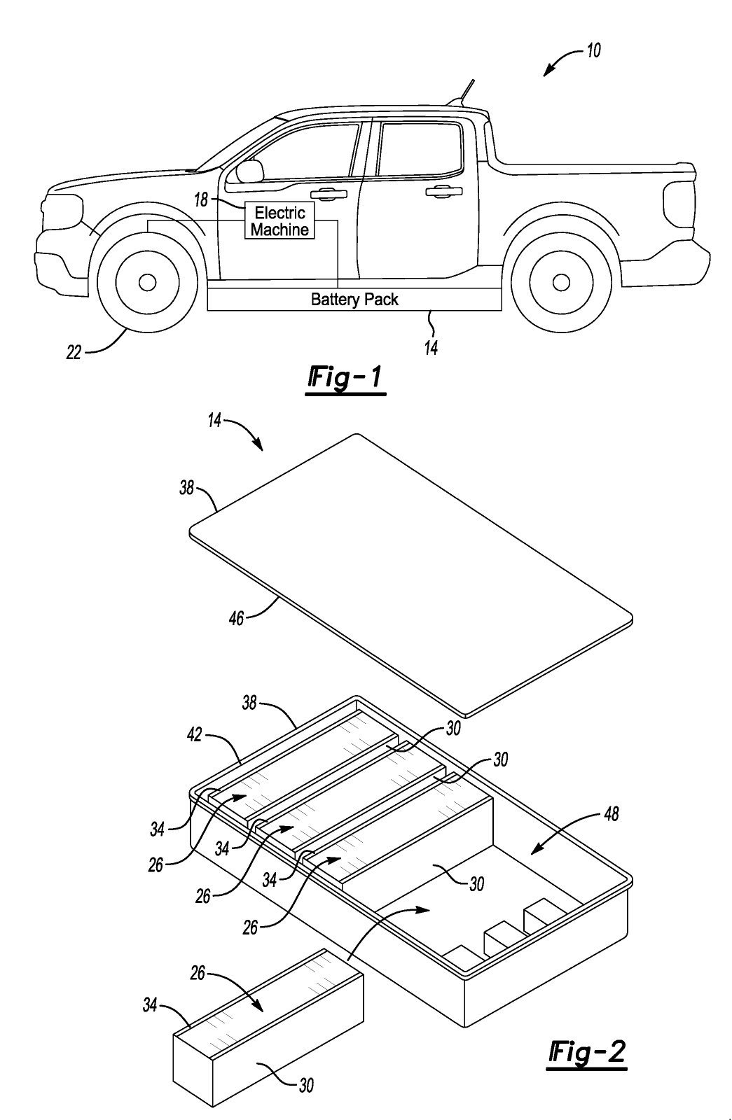

With reference now to the highly schematic view of FIG. 2, the traction battery pack 14 includes, in the exemplary embodiment, a plurality of a cell stacks 26 each disposed between a first side frame 30 and a second side frame 34. The cell stacks 26, first side frames 30, and second side frames 34 are held within an enclosure assembly 38.

The enclosure assembly 38 includes an enclosure tray 42 and an enclosure cover 46 that are joined together to provide an interior 48 that houses the cell stacks 26, the first side frames 30, and the second side frames 34.

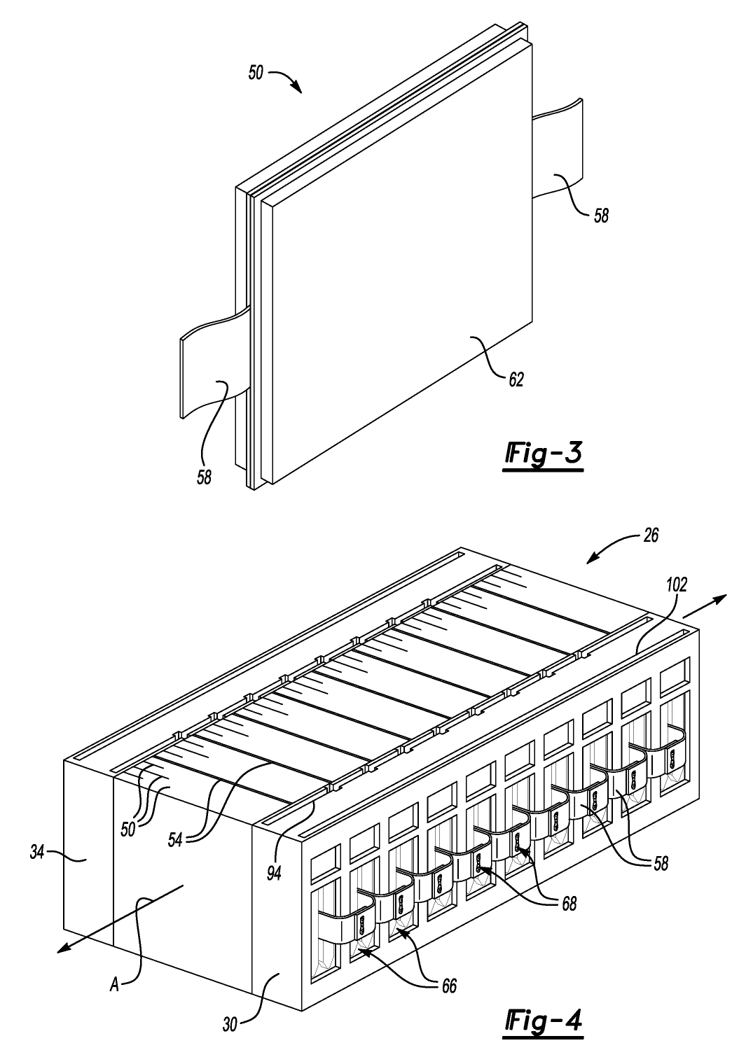

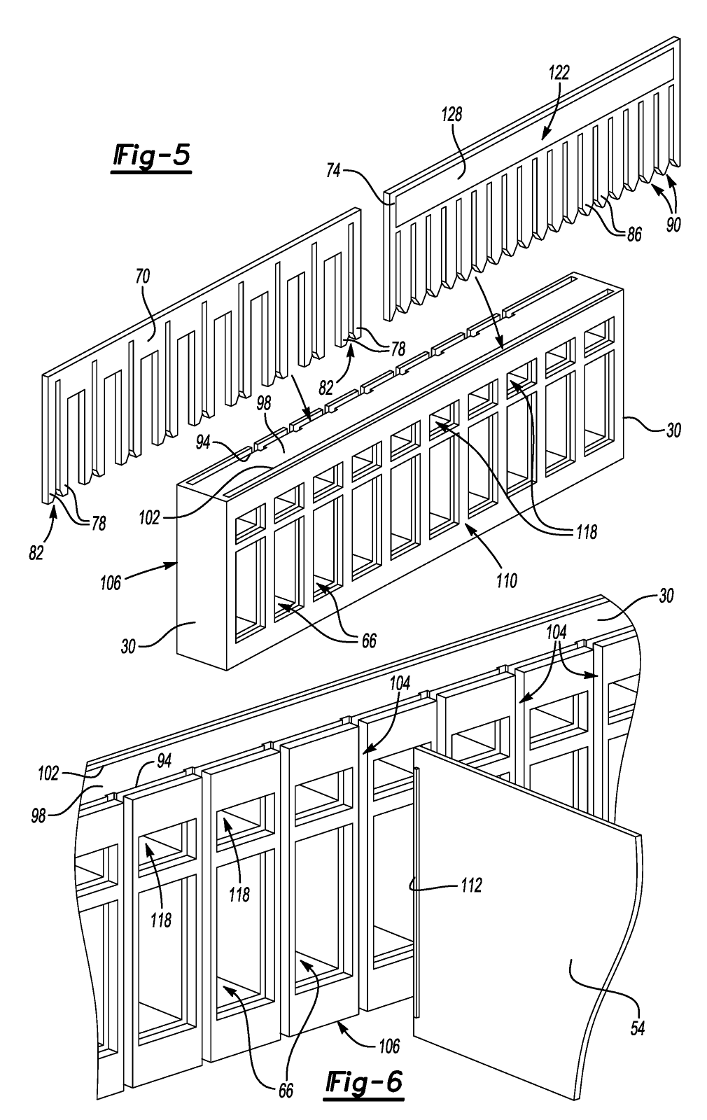

With reference now to FIGS. 3–5, each of the cell stack 26 includes a plurality of individual battery cells 50 and a plurality of thermal barriers 54 disposed along a respective cell stack axis A. In this example, the battery cells 50 are segregated into groups of at least two battery cells 50 that are separated from each other along the respective cell stack axis A by one of the thermal barriers 54.

The battery cells 50 store and supply electrical power for powering various components of the electrified vehicle 10. In this example, one of the thermal barriers 54 is disposed between groups of four of the battery cells 50 along the cell stack axis A. The battery cells 50 and thermal barriers 54 of the cell stack 26 can be positioned between endplates (not shown) and compressed along the cell stack axis A.

In the exemplary embodiment, the battery cells 50 are lithium-ion pouch-style battery cells. However, battery cells having other geometries (cylindrical, prismatic, etc.) and/or chemistries (nickel-metal hydride, lead-acid, etc.) could alternatively be used within the scope of this disclosure.

The battery cells 50 each include tab terminals 58 extending from a case 62. In the battery pack 14, the tab terminals 58 of the example battery cells 50 on first side of the cell stack 26 each extend through an aperture 66 in the first side frame 30. The tab terminals 58 are folded over the first side frame 30 and are connected together via welds 68, which can be laser welds, for example. In this example, the tab terminals 58 are electrically connected without the use of busbars. In other examples, the first side frame 30 holds busbars, and the tab terminals 58 are electrically connected together via the welds 68.

The tab terminals 58 on an opposite second side of the cell stack 26 extend through an opening in the second side frame 34 and are also connected together via welds

The battery pack 14 includes, in this example, a thermal barrier holder 70 and a terminal holder 74 that are each separately slidably engageable with the first side frame 30. The thermal barrier holder 70 and the terminal holder 74 are both types of pectinated holders, which means that the thermal barrier 54 and the terminal holder 74 are substantially comb-shaped.

The thermal barrier holder 70 includes a plurality of fingers 78 with slots 82 between the fingers. The terminal holder 74 includes a plurality of fingers 86 and a plurality of slots 90 between the fingers 86.

The first side frame 30, in this example, includes a first opening 94 that opens to an upper side 98 of the first side frame 30, and a second opening 102 that also opens to the upper side 98. The upper side 98 of the first side frame 30 is transverse to a first side 106 of the first side frame 30 an opposing second side 110 of the first side frame 30. The first opening 94 is configured to slidably receive the thermal barrier holder 70. The second opening 102 is configured to slidably receive the terminal holder 74. Although disclosed as opening to the upper side 98, the first opening 94, the second opening 102, or both could open to other sides of the first side frame 30 in other examples.

In this example, the first side frame 30, the thermal barrier holder 70, and the terminal holder 74 are all made of material having a high dielectric strength. The first side frame 30, the thermal barrier holder 70, and the terminal holder 74, in this example, are electrically isolative and substantially non-conductive as these components interface with other components having different voltage potentials. These components could be made of materials such as polymer-based materials, ceramics, carbon fiber material.

In the exemplary embodiment, the terminal holder 74 can slidably engage with the first side frame 30 separately from the thermal barrier holder 70.

During assembly, the first side frame 30 is positioned alongside the cell stack 26 with first side 106 directly interfacing with the cell stack 26 as shown in FIG. 6. In FIG. 6, only one thermal barrier 54 is shown. The remaining portions of the cell stack 26 are omitted for clarity.

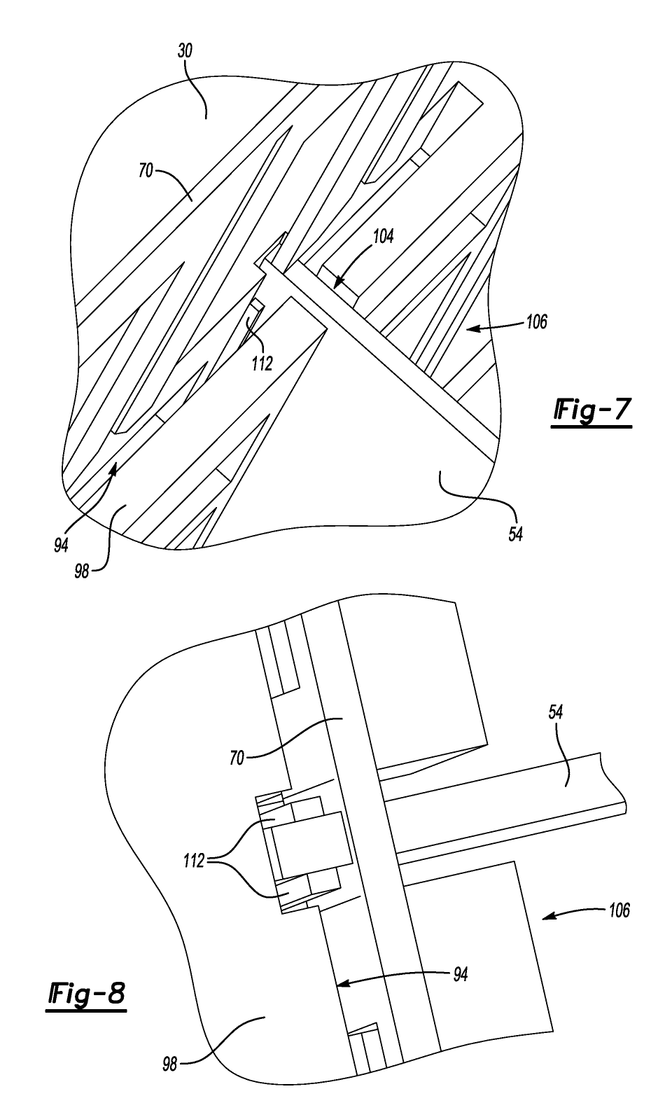

The first side frame 30 and cell stack 26 are then moved closer together until the thermal barriers 54 fit within respective grooves 104 of the first side frame 30 as shown in FIG. 7. Next, the thermal barrier holder 70 is then inserted in the opening 94 and slid vertically downward into the opening 102 to engage with the first side frame 30 until reaching the position shown in FIG. 8. The fingers 78 can be tapered at ends to facilitate installation of the thermal barrier holder 70 into the openings 102.

As the thermal barrier holder 70 moves vertically downward, outboard edge portions of the thermal barriers 54 fit into the slots 82 between the fingers 78 of the thermal barrier holder 70. The outboard edge portions of the thermal barriers 54 project outward past the cases 62 of the battery cells 50.

When the thermal barrier holder 70 is fully received within the opening 94, the fingers 78 of the thermal barrier holder 70 are positioned on opposite axial sides of the thermal barriers 54. The outboard edge portions of the thermal barriers 54 include axially protruding ribs 112, which can help to guide the thermal barrier holder 70 into the installed position and can keep the thermal barrier 54 from withdrawing from within the slot 90.

The fingers 78 can help to secure the thermal barriers 40. During operation, securing the thermal barriers 40 can help to inhibit vibration, for example, by limiting axial movement of the thermal barriers 40. Further, should one of the battery cells 50 of the cell stack 26 begin to vent and expel vent byproducts, the thermal barrier holder 70 can block flow of vent byproducts from moving past areas near the outboard edges of the thermal barriers 40.

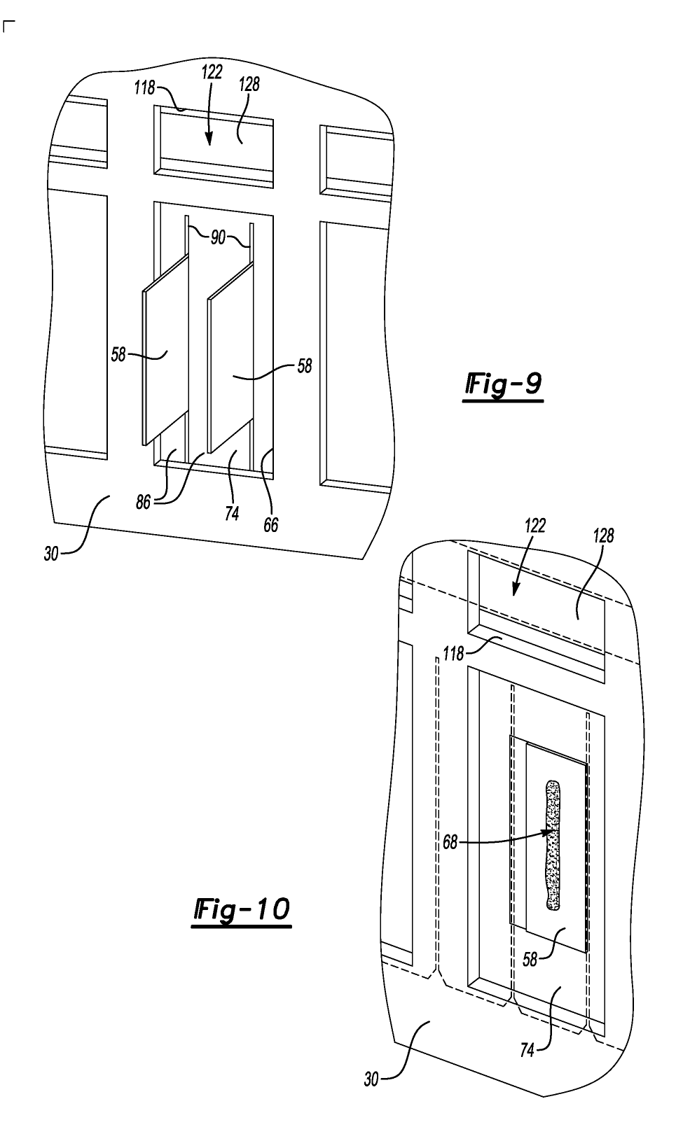

With reference to FIGS. 4, 5, 9, and 10, vertically above the apertures 66 in the first side frame 30 that receive the terminals 58 are a plurality of frame vent openings 118. Vent byproducts blocked by the thermal barrier holder 70 are redirected outward away from the cell stack axis A and can move upward toward the frame vent openings 118.

During assembly, after the first side frame 30 is positioned alongside the cell stack 26, the terminals 58 are then extended through the aperture 66 from the first side 106 of the first side frame 30 to the second side 110 of the first side frame 30. The terminal holder 74 is slideably engaged with the first side frame 30 by inserting the terminal holder 74 downward into opening 102 of the first side frame 30.

As the terminal holder 74 is moved downward, the terminals 58 are received within the slots 90. After the terminal holder 74 is seated, the terminals 58 can be folded over each other, over the fingers 86, and over portions of the first side frame 30. When fully seated, ends of the fingers 86 can be received within a groove of the first side frame 30. This can help to stabilize the fingers 86 and other portions of the terminal holder 75. Ends of the fingers 86 can be tapered to facilitate insertion.

In the FIG. 4 example, the terminals 58 are folded over portions of the first side frame 30. In the FIG. 10 example, the terminals 58 are folded over only the terminal holder 74.

After folding the terminals 58, a laser welder can be utilized to weld together the terminals 58 to electrically connect together the terminals 58. During welding, the fingers 86 can block splatter associated with the welding from moving back through the apertures 66 toward the cases 62 of the battery cells 50. The terminal holder 74 thus provides a splatter shield when welding the terminals 58. The fingers 86 can also provide a reaction member that supports the terminals 58 as tooling presses together the terminals 58 during welding. The ends of the fingers 86 being received within the groove can help to resist pressure applied by the tooling.

The terminal holder 74 includes a holder vent opening 122 that aligns with the frame vent opening 118 in the first side frame 30 when the terminal holder 74 is engaged with the first side frame 30. The holder vent opening 122 in the terminal holder 74 is covered by a membrane 128 when the terminal holder 74 is installed.

During a venting event, vent byproducts, including vent byproducts redirected by the thermal barrier holder 70 can rupture the membrane 128 to move through the holder vent opening 122 and the vent in the terminal holder 74 and the remaining portions of the holder vent opening 122 until the vent byproducts are outboard the first side frame 30 within the interior 48. From there, there vent byproducts can be vented from the battery pack 14.

The example thermal barrier holder 70 and terminal holder 74 are described above in connection with the first side frame 30. The second side frame 34 can accommodate another thermal barrier holder 70 and another terminal holder 74 that slidably engage with the second side frame 34 in a manner similar to that described in connection with the first side frame 30. Each of the first side frames 30 and second side frames 34 can be constructed similarly to the example shown in FIG. 3.

Features of the disclosed embodiments include utilizing holders to slidably engage with the side frame of a battery pack to secure together components of the battery pack and, potentially, shield areas of the battery pack and redirect vent byproducts. The side frames can be installed alongside the cell stack with relatively large clearances to facilitate assembly. The holders can be pectinated holders introduced to more tightly hold components such as the thermal barrier and terminals of the battery pack. The holders thus facilitate assembly.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cell stack including a plurality of battery cells disposed along a cell stack axis;
a side frame alongside the cell stack, the plurality of battery cells having a plurality of terminals that each extend through one of a plurality of apertures in the side frame; and
a pectinated holder that slidably engages the side frame.

2. The battery pack assembly of claim 1, wherein the pectinated holder and the side frame are an electrically insulative material.

3. The battery pack assembly of claim 1, wherein the pectinated holder includes a plurality of slots that receive at least one terminal within the plurality of terminals.

4. The battery pack assembly of claim 1, wherein the pectinated holder is slidably received within at least one opening in the side frame when the pectinated holder engages the side frame.

5. The battery pack assembly of claim 4, wherein the plurality of apertures in the side frame each extends from a first side of the side frame, through the side frame, to an second side of the side frame, the second side opposite the first side, wherein the at least one opening opens to a third side of the side frame that is transverse to both the first side and the second side.

6. The battery pack assembly of claim 5, wherein the third side is an upper side of the side frame.

7. The battery pack assembly of claim 4, wherein the pectinated holder includes a plurality of fingers, the plurality of terminals extending between the plurality of fingers when the pectinated holder engages the side frame.

8. The battery pack assembly of claim 7, wherein the pectinated holder slidably engages with the side frame to position the plurality of terminals between the plurality of fingers.

9. The battery pack assembly of claim 1, further comprising a battery pack enclosure providing an interior, the cell stack and the side frame housed within the interior.

10. The battery pack assembly of claim 9, wherein the cell stack includes a plurality of thermal barriers, wherein the pectinated holder includes a plurality of slots that each receive a portion of at least one thermal barrier within the plurality of thermal barriers.

11. The battery pack assembly of claim 10, wherein the pectinated holder is configured to limit axial movement of the plurality of thermal barriers.

12. The battery pack assembly of claim 1, wherein the pectinated holder is a first pectinated holder that includes a plurality of first slots that each receive at least one terminal within the plurality of terminals, and further comprising a second pectinated holder that slidably engages the side frame.

13. The battery pack assembly of claim 12, wherein second pectinated holder includes a plurality of slots that each receive a portion of at least one thermal barrier of the cell stack.

14. The battery pack assembly of claim 1, wherein the pectinated holder includes at least one vent opening.

15. The battery pack assembly of claim 14, further comprising a membrane that covers the at least one vent opening.

16. A battery pack assembly, comprising:
a cell stack having a plurality of battery cells and a plurality of thermal barriers disposed along a cell stack axis;
a side frame alongside the cell stack; and
a thermal barrier holder that slidably engages with the side frame and is configured to receive a portion of at least one of the thermal barriers within the plurality of thermal barriers.

17. The battery pack assembly of claim 16, wherein the thermal barrier holder is comb-shaped.

18. The battery pack assembly of claim 16, further comprising a terminal holder that slidably engages with the side frame separately from the thermal barrier holder.

19. The battery pack assembly of claim 18, wherein the plurality of battery cells include a plurality of tab terminals, at least some of the tab terminals within the plurality of tab terminals received within a slot of the terminal holder.
